(19) United States
(12) Patent Application Publication
(10) Pub. No.: US 2007/0260938 A1
(43) Pub. Date: Nov. 8, 2007

(54) Method, code, and apparatus for logging test results

(76) Inventors: Carli Connally, Fort Collins, CO (US); Reid F. Hayhow, La Porte, CO (US); Kristin N. Casterton, Fort Collins, CO (US); Robert S. Kolman, Longmont, CO (US)

Correspondence Address: VERIGY, 4700 INNOVATION WAY, BLDG D1, FORT COLLINS, CO, 80528, US

(21) Appl. No.: 11/410,741

(22) Filed: Apr. 24, 2006

(51) Int. Cl. G06F 11/00

(52) U.S. Cl. 714/45

(57) ABSTRACT

In one embodiment, a method for logging test results, has steps for: A) accessing a stream of test data associated with a tester performing tests on a number of devices under test; B) selecting items of the test data to be logged to a data store, the selecting being performed in accord with a number of test data formatting selections; and C) logging the selected items of the test data.

### BACKGROUND

Testers, such as the 93000 System-on-Chip (SOC) tester from Agilent Technologies, perform tests on devices under test (DUTs) and report the results of those tests. The test data produced by a tester may include the test results as well as additional data (e.g., test indicia, user data, environment data, timestamps, et cetera). The test data is then analyzed or stored for later analysis. The amount of data produced can vary from voluminous verbose data, wherein all or nearly all events (e.g., stimuli and test results) contribute to the test data, to minimal, wherein summary data is produced.

If a test is setup to generate too little test data, the test may not have enough information and need to be repeated. This is particularly burdensome when the tester is left to run autonomously and the output examined only after hours or even days of testing. If a test is setup to generate more data than what is needed then resources are wasted and test performance may even be diminished.

### SUMMARY OF THE INVENTION

In one embodiment, a method for logging test results, comprises: A) accessing a stream of test data associated with a tester performing tests on a number of devices under test; B) selecting items of the test data to be logged to a data store, the selecting being performed in accord with a number of test data formatting selections; and C) logging the selected items of the test data.

In another embodiment, one or more machine-readable mediums having stored thereon sequences of instructions, which, when executed by a machine, cause the machine to perform the actions of: A) accessing a stream of test data associated with a tester performing tests on a number of devices under test; B) selecting items of the test data to be logged to a data store, the selecting being performed in accord with a number of test data formatting selections; and C) logging the selected items of the test data.

In another embodiment, an apparatus comprises: A) a first interface to access a stream of test data associated with a tester performing tests on a number of devices under test; B) a second interface to access a data store; C) a processor to select items of the test data to be logged to the data store, the processor selecting items of the test data in accord with a number of test data formatting selections; and D) an output to log the selected items of the test data to the data store.

Other embodiments are also disclosed.

### BRIEF DESCRIPTION OF THE DRAWINGS

Illustrative embodiments of the invention are illustrated in the drawings, in which:

FIG. 1 illustrates an exemplary method for logging test results; and

FIG. 2 illustrates an exemplary apparatus for executing a method, such as in FIG. 1, for logging test results.

### DETAILED DESCRIPTION

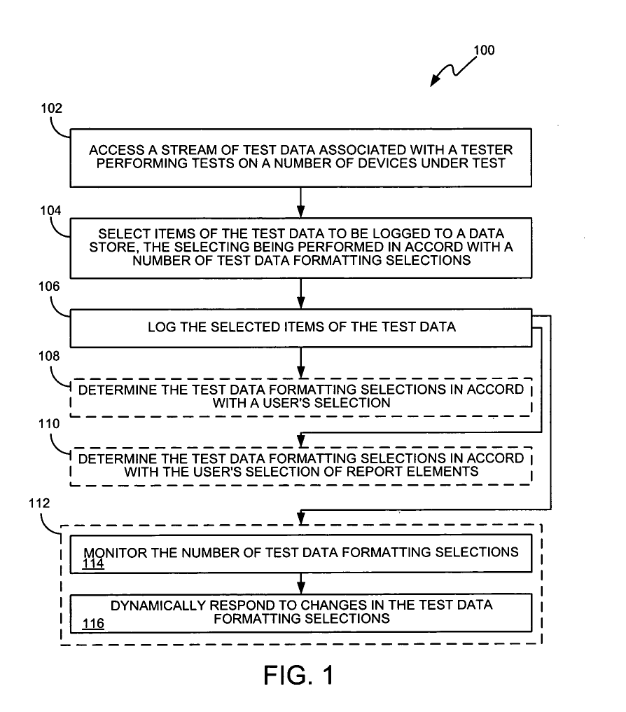

FIG. 1 illustrates exemplary method 100 for logging test results. Method 100 includes steps 102, 104, 106 for: A) accessing a stream of test data associated with a tester performing tests on a number of devices under test; B) selecting items of the test data to be logged to a data store, the selecting being performed in accord with a number of test data formatting selections; and C) logging the selected items of the test data.

By selecting the items of the test data to be logged to the data store, in accord with the number of test data formatting selections, logging then logs those items that are needed for processing (e.g., formatting, organizing, analyzing, presenting) without wasting resources.

Upon executing step 106, step 108 is optionally executed for determining the test data formatting selections in accord with a user's selection. The user may be either an electronic user (e.g., program, agent, routine) or a human user interacting with a user interface. The user may also be presented with a list of potential test data formatting selections to facilitate the user's evaluation and selection of the test data formatting selections.

In one embodiment, the items of the test data to be logged are selected in accord with a union of test data to be formatted by a number of formatters. Formatters put the logged test data into a form usable for other processes not operable to read the logged test data, such as, analysis, presentation, storage, or additional formatting. One formatter may format specific format types, such as, STDF (Standard Test Data Format, occasionally also known as Standard Teradyne Data Format), XML (eXtensible Markup Language), HTML (HyperText Markup Language), and other standard or custom format types. As such, certain data items are of a type relevant to certain formatters and the test data formatting selections cause the logging of the associated items of the test data for use by the data formatters. When more than one formatter reads the logged test data, a union of each formatters' required test data selections form the number of test data formatting selections.

In another embodiment, the items of the test data to be logged are selected in accord with a union of elements of test reports to be generated. For example, one test report is concerned with pin data and a second test report is concerned with error data, then the items of the test data logged is in accord with both formatting selections. A test report may be produced by more than one formatter, such as when each formatter produces formatted data of a different format type (e.g., HTML, XML) or different formatters may produce different test reports (e.g., summary data, pin data, errors).

Upon executing step 106, step 1 10 is optionally executed to determining the test data formatting selections in accord with a user's selected test data formatting selections. Ones of the test data formatting selections maps to a number of items of the test data to be logged. For example, a test data formatting selection of “pin failure” is associated with items of the test data that are of type “pin data” and “failure data”. By logging “pin data” and “failure data” the desired “pin failure” test data may be produced from the logged data. In another example, a test data formatting selection of “header” may be associated with items of the test data that include “user”, “tester number”, “DUT serial number”, “date”, and “time.” Therefore, the selection of “header” logs a plurality of test data items.

Upon executing step 106, steps 112 are optionally executed to execute steps 114 and 116 to A) monitoring the number of test data formatting selections; and B) dynamically responding to changes in the test data formatting selections. The user may select the number of test data formatting selections prior to the accessing of the stream of test data or after the initial accessing occurs. If changes are made to the number of test data formatting selections while executing selection step 104 or logging step 106, the logging step 106 will reflects the change. In one example, a user monitoring logged items of the test data may initially set the number of test data formatting selections to a more verbose level of logging, such as when an initial test or DUT is potentially error prone. Upon determining that the test or DUT is not creating certain errors, a user may then deselect ones of the number of test data formatting selections to then cause the unneeded test data items to cease being logged.

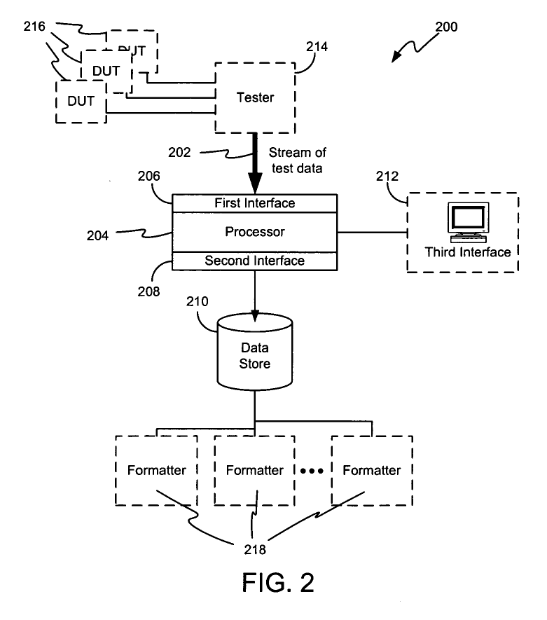

FIG. 2 illustrates exemplary apparatus 200 for executing a method, such as in FIG. 1, for logging test results. Stream of test data 202 is accessed by first interface 206. Processor 204 selects items of the test data to be logged to data store 210. Second interface 208 then communicates with data store 210 for the storage of the selected test data. In one embodiment, processors 204 may be one or more computing device executing processing instructions. In another embodiment, processor 204 may be one or more computing systems executing processing instructions. In one embodiment, first interface 206 and second interface 208 are components (e.g., processes, ports) of processor 204.

Optionally, third interface 212 receives a user's number of test data formatting selections. In one embodiment third interface 212 may be integrated into processor 204.

Logged test data is available in data store 210 for access, such as by optional formatters 218.

In one embodiment, such as illustrated in FIG. 2, stream of test data 202 is retrieved from tester 214 performing tests on a number of DUTs 216. In another embodiment, stream of test data 202 may be retrieved as an artifact of a prior test performed on one or more DUTs.

What is claimed is:

1. A method of logging test results, comprising:
accessing a stream of test data associated with a tester performing tests on a number of devices under test;
selecting items of the test data to be logged to a data store, the selecting being performed in accord with a number of test data formatting selections; and
logging the selected items of the test data.

2. The method of claim 1, further comprising, determining the test data formatting selections in accord with a user's selection.

3. The method of claim 2, further comprising, determining the test data formatting selections in accord with the user's selection of report elements.

4. The method of claim 1, further comprising:
monitoring the number of test data formatting selections; and
dynamically responding to changes in the test data formatting selections.

5. The method of claim 1, wherein the items of the test data to be logged are selected in accord with a union of test data to be formatted by a number of formatters.

6. The method of claim 1, wherein the items of the test data to be logged are selected in accord with a union of elements of test reports to be generated.

7. The method of claim 1, wherein:
selecting ones of the test data to be logged, further comprises scrubbing test data not to be logged from the test data; and
logging the selected test data, further comprises, logging the test data not scrubbed.

8. One or more machine-readable mediums having stored thereon sequences of instructions, which, when executed by a machine, cause the machine to perform the actions of:
accessing a stream of test data associated with a tester performing tests on a number of devices under test;
selecting items of the test data to be logged to a data store, the selecting being performed in accord with a number of test data formatting selections; and
logging the selected items of the test data.

9. The machine-readable mediums of claim 8, further comprising instructions, which when executed by the machine, cause the machine to perform the action of determining the test data formatting selections in accord with a users selection.

10. The machine-readable mediums of claim 9, further comprising instructions, which when executed by the machine, cause the machine to perform the action of determining the test data formatting selections in accord with the user's selection of report elements.

11. The machine-readable mediums of claim 8, further comprising instructions, which when executed by the machine, cause the machine to perform the actions of:
monitoring the number of test data formatting selections; and
dynamically responding to changes in the test data formatting selections.

12. The machine-readable mediums of claim 8, further comprising instructions, which when executed by the machine, cause the machine to perform the action of logging the selected items of the test data in accord with a union of test data to be formatted by a number of formatters.

13. The machine-readable mediums of claim 8, further comprising instructions, which when executed by the machine, cause the machine to perform the action of logging the selected items of the test data in accord with a union of elements of test reports to be generated.

14. The machine-readable mediums of claim 8, further comprising instructions, which when executed by the machine, cause the machine to perform the actions of:
selecting ones of the test data to be logged, further comprises scrubbing test data not to be logged from the test data; and
logging the selected test data, further comprises, logging the test data not scrubbed.

15. Apparatus, comprising:
a first interface to access a stream of test data associated with a tester performing tests on a number of devices under test;
a second interface to access a data store; and
a processor to select items of the test data to be logged to the data store, the processor selecting items of the test data in accord with a number of test data formatting selections.

16. The apparatus of claim 15, wherein the apparatus further comprises a third interface to receive at least one of the number of test data formatting selections from a user.

17. The apparatus of claim 16, wherein the third interface further comprises a prompt, the prompt presenting potential test data formatting selections to facilitate the users selection.

18. The apparatus of claim 15, wherein the processor reselects items of the test data to be logged upon the number of test data formatting selections being updated.

19. The apparatus of claim 15, wherein the processor selects items of the test data to be logged in accord with a union of test data to be formatted by a number of formatters.

20. The apparatus of claim 15, wherein the processor selects items of the test data to be logged in accord with a union of elements of test reports to be generated.

21. The apparatus of claim 15, wherein:
the processor selects ones of the test data to be logged by scrubbing test data not to be logged from the test data; and
the processor causes the test data not scrubbed to be logged.
